(19) United States
(12) Patent Application Publication
(10) Pub. No.: US 2012/0201595 A1
(43) Pub. Date: Aug. 9, 2012

(54) Outer Race Connection

(75) Inventors: Steven C. Hahn, Shelby Township, MI (US); John Littlewood, Tamworth (GB)

(73) Assignee: GKN DRIVELINE NORTH AMERICA, INC., Auburn Hills, MI (US)

(21) Appl. No.: 13/501,743

(22) PCT Filed: Oct. 12, 2009
(86) PCT No.: PCT/US09/60363

§ 371 Date: Apr. 12, 2012

(51) Int. Cl. F16D 3/02

(52) U.S. Cl. 403/164

(57) ABSTRACT

An outer joint portion (42) for an articulating joint (26) is provided, the outer joint portion (42 including a first outer joint diameter section (DO1), a second outer joint diameter section (DO2), a main portion (86), and an inner bore (76). The first outer joint diameter section (DO1) is defined by a first portion of an outer surface (88) of the outer joint portion (42). The second outer joint diameter section (D02) is defined by a second portion of the outer surface (88) of the outer joint portion (42). The main portion (86) is configured for housing inner components (44, 46) of an articulating joint (26). The inner bore (76) is located at the second portion of the outer surface (88). The outer joint portion (42) is selectively compressible at the second portion of the outer surface (88), and the inner bore (76) configured for selectively receiving and securing to a shaft (30) when the outer joint portion (42) is compressed.

### TECHNICAL FIELD

The present invention relates to an outer joint portion for an articulating joint.

### BACKGROUND ART

Universal joints, and especially constant velocity joints, operate to transmit torque between two rotational members. Constant velocity joints and similar rotating couplings may include an inner race and an outer race. In at least one type of constant velocity joint, the inner race may be directly connected to a torque-transmitting shaft, such as an input shaft or an output shaft, where the inner race includes a splined inner diameter splined to the shaft.

Sometimes the spline size of the inner race may be increased in order to accommodate the spline size of the mating shaft. In one particular type of constant velocity joint, such as a direct torque flow connection, the inner race is splined to the input shaft, where the input shaft is part of the transmission. Because the input shaft is part of the transmission, it may be more difficult and costly to change the spline size of the transmission shaft when compared to changing the size of the inner race. As a result, the spline size of the inner race may be increased instead.

However, increasing the spline size of the inner race may require also enlarging the wall thickness and size the inner race, which in turn adds to the size and mass of the constant velocity joint. For example, non-standardized internal components, such as a larger constant velocity joint cage and balls, may be needed to accommodate the larger inner race.

The outer race may not be limited in spline size like the inner race, where increasing the spline size may require a larger, heavier constant velocity joint. Accordingly, there exists a need for an outer race that may be connected to a shaft.

### BRIEF DESCRIPTION OF DRAWINGS

FIG. 1 is a partial cross sectional view of a joint including a joint assembly that is connected to a first shaft and a second shaft;

FIG. 2 is a partial cross sectional view of the joint including an outer joint portion, an inner joint portion, a fastening device and the second shaft;

FIG. 3 is a cross sectional view of the fastening device as illustrated in FIG. 2;

FIG. 4A is alternative illustration of the outer joint portion and the fastening device illustrated in FIG. 2;

FIG. 4B is an end view of the outer joint portion and the fastening device illustrated in FIG. 4A;

FIG. 5A is alternative illustration of the outer joint portion and the fastening device illustrated in FIG. 2; and

FIG. 5B is an enlarged view of Area 5B in FIG. 5A.

### DETAILED DESCRIPTION

Exemplary illustrations are described below. In the interest of clarity, not all features of an actual implementation are described in this specification. It will of course be appreciated that in the development of any such actual implementation, numerous implementation-specific decisions must be made to achieve the developers' specific goals, such as compliance with system-related and business-related constraints that will vary from one implementation to another. Moreover, it will be appreciated that such a development effort might be complex and time-consuming, but would nevertheless be a routine undertaking for those of ordinary skill in the art having the benefit of this disclosure.

According to various exemplary illustrations described herein, an outer joint portion for an articulating joint may be provided, including a first outer joint diameter section, a second outer joint diameter section, a main portion and an inner bore. The first outer joint diameter section may be defined by a first portion of an outer surface of the outer joint portion. The second outer joint diameter section may be defined by a second portion of the outer surface of the outer joint portion. The main portion may be for housing inner components of an articulating joint, where the first outer joint diameter section may be measured at the main portion. The inner bore may be located at the second portion of the outer surface of the outer joint portion, where the outer joint portion may be selectively compressible at the second portion of the outer surface, and the inner bore may be for selective connection to a shaft when the outer joint portion is compressed.

An articulating joint may also be provided, including an outer joint portion. The outer joint portion may include a first outer joint diameter section and a second outer joint diameter section, where the first outer joint diameter section is defined by a first portion of an outer surface of the outer joint portion, and the second outer joint diameter section may be defined by a second portion of the outer surface of the outer joint portion. An inner bore of the outer joint portion may be located at the second portion of the outer surface of the outer joint portion, where the outer joint portion may be selectively compressible at the second portion of the outer surface of the outer joint portion, and the inner bore may be for selective connection to a shaft when the outer joint portion is compressed. The first outer joint diameter section may be greater than the second outer joint diameter section. The articulating joint may further include a fastening device clamped at the outer surface of the outer joint portion at the second portion of the outer surface.

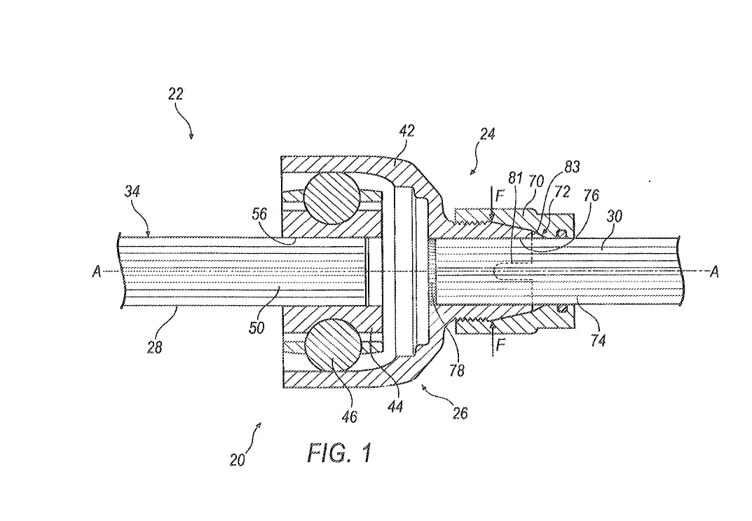

Turning now to the illustrations, FIG. 1 illustrates an exemplary joint 20 having a driven end 22 and a driving end 24, however, it should be noted that the driven end 22 can also be the driving end 24, and the driving end 24 can also be the driven end 22. The joint 20 further includes a joint assembly 26 that may be coupled to a first shaft 28 at the driven end 22, and a second shaft 30 at the driving end 24. In the embodiment shown, the joint assembly 26 further includes a plurality of balls 46, an outer joint portion 42, and an inner joint portion 44. It should be noted that while FIG. 1 illustrates the joint assembly 26 as a constant velocity joint, any type of articulated joint, such as, but not limited to, a plunging, fixed, universal, tripod or Carden joint may be used.

Turning to the driving end 24, the joint assembly 26 may be connected to the second shaft 30 by the outer joint portion 42. The outer joint portion 42 may be clamped to the second shaft 30 by a fastening device 70. The fastening device may exert a compressive force F along at least a portion of the outer joint portion 42 in contact the second shaft 30 at an outer joint portion extension 72. The outer joint portion extension 72 may be a portion of the outer joint portion 42 for connecting the outer joint portion 42 to a shaft, such as second shaft 30.

In one exemplary illustration, the second shaft 30 includes an outer splined surface 74, and the outer joint portion extension 72 includes an inner bore surface 76. The inner bore surface 76 includes a splined portion 78 for connection to the second shaft 30. That is, the outer splined surface 74 of the second shaft 28 may be engaged with the splined portion 78 of the outer joint portion extension 72, and which may serve as the connection between the joint assembly 26 and the second shaft 30. It should be noted that while the inner joint portion 44 and the outer joint portion 42 are illustrated to include splined connections to the first and second shafts 28 and 30, any type of selectively releasable connection may be used as well.

In one example, the fastening device 70 may be a compression nut, however, it should be noted that any type of device that exerts a compressive force to the outer joint portion 42 may also be used, such as, but not limited to, a clamp, castellated nut or collet. The fastening device 70 may compress the outer joint portion 42 along at least a portion of the outer joint portion 42 where the outer joint portion 42 and the second shaft 30 are connected to one another. The portion of the outer joint portion 42 where the outer joint portion 42 and the second shaft 30 are connected to one another may be the outer joint portion extension 72, however, it should be noted that other portions of the outer joint portion 42 may be used as well. The fastening device 70 may allow for axial retention of the second shaft 30 to the joint assembly 26, especially during operation of the joint 20. FIG. 1 illustrates the fastening device 70 threadingly engaged with the outer joint portion extension 72, however, it should be noted that other fastening approaches other than threads may be used as well.

The joint 20 may be utilized on both ends of an exemplary propshaft assembly for transmitting torque. For example, one joint could be used at one end of an exemplary propshaft for connecting to an output shaft, and another joint 20 could be used at the other end for connecting to an input shaft. Providing connection from the joint assembly 26 to the second shaft 30 by the outer joint portion 42 may provide an advantage when compared to providing a connection from a joint assembly to a shaft by the inner joint portion, and in particular a connection between a shaft to the inner joint portion. This is because in at least some types of constant velocity joints where the joint is connected to the shaft at the inner joint portion, only one constant velocity joint may be utilized. In other words, a constant velocity joint may only be included on one end of the propshaft, as a spline connection at the inner joint portion may require more packaging space.

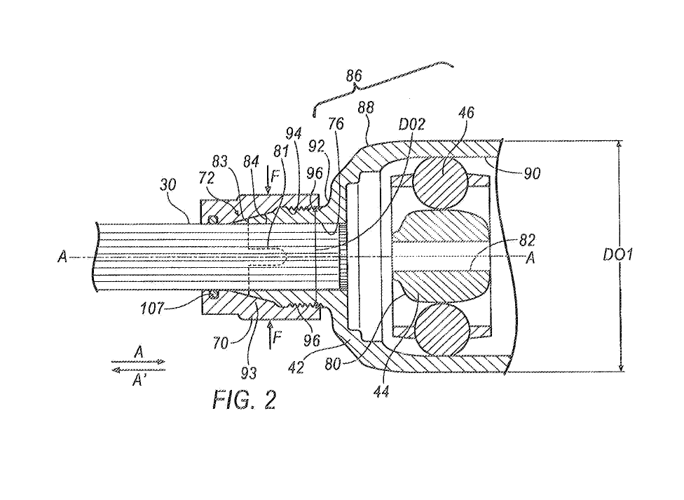

FIG. 2 is a partial sectioned view of the outer joint portion 42, the inner joint portion 44, the second shaft 30 and the fastening device 70. In one exemplary embodiment, the inner joint portion 44 includes an outermost inner joint portion surface 80 and an inner joint portion inner surface 82. The outermost inner joint portion surface 80 and the inner joint portion inner surface 82 may be annular surfaces that are coaxial.

The outer joint portion 42 includes an outermost outer joint portion surface 88, as well as an inner surface 90. The outermost outer joint portion surface 88 and the inner surface 90 may be annular surfaces that substantially correspond with one another and are coaxial.

The outer joint portion 42 also includes at least two different diameters that are measured along the outermost outer joint portion surface 88; a first outer joint outer diameter DO1 and a second outer joint outer diameter DO2. The outermost outer joint portion surface 88 and the inner surface 90 transition between a main portion 86 of the outer joint portion 42 to the outer joint portion extension 72 at a transitioning area 92. That is, the transitioning area 92 may be a portion of the outer joint portion 42 where the diameter of the outer joint portion 42 transitions from the first outer joint outer diameter DO1 to the second outer joint outer diameter DO2.

The main portion 86 of the outer joint portion 42 may be where the inner components of the joint assembly 26 are housed. For example, the main portion 86 may house components such as the inner joint portion 44 and the plurality of balls 46. The outer joint portion 42 transitions at the transitioning area 92 from the main portion 86 that includes a greater first outer joint outer diameter DO1 to the outer joint portion extension 72 that includes a smaller second outer joint outer diameter DO2. In other words, the diameter of the main portion 86 may be greater than the diameter of the outer joint portion extension 72.

The first outer joint outer diameter DO1 is measured at the maximum diameter of the main portion 86 of the outer joint portion 42. FIG. 2 illustrates the first outer joint outer diameter DO1 as being greater than the second outer joint outer diameter DO2. However, it should be noted that the first outer joint outer diameter DO1 and the second outer joint outer diameter DO2 may also be about equal, while at least the first outer joint outer diameter DO1 may be greater than an inner joint outer diameter. (not shown)

The inner bore surface 76 may be located in the outer joint portion extension 72, where the second outer joint portion diameter DO2 is measured. The outer joint portion extension 72 may be compressible to at least the second outer joint diameter DO2, where the fastening device 70 compresses the outer joint portion extension 72. To facilitate such compression, in one embodiment, outer joint portion extension 72 further comprises one or more relief slots 81 (shown in phantom in FIG. 2). Relief slots 81 are configured to extend into inner bore defined by inner bore surface 76, from a front face 83 of outer joint portion extension 72 between the outer surface of outer joint portion extension 72 and the inner bore surface 76. The one or more relief slots 81 allow the inner bore along the relief slots 81 to be decreased when compressive forces are applied to the outside surface of the outer joint portion extension 72. Thus, the inner bore surface 76 may be selectively connected to a shaft, such as the second shaft 30. In particular, the inner bore surface 76 may be splined to the second shaft 30 when the outer joint portion 42 is compressed at the inner bore surface 76. The inner bore surface 76 may be compressed by way of the fastening device 70, which exerts the compressive force F on at least the inner bore surface 76 of the outer joint portion 42, thereby clamping and axially retaining the shaft 30 to the outer joint portion 42. It is recognized that any number of slots 81 may be utilized to effect compression of the outer joint portion extension 72 for axial retention upon a shaft 30. Where multiple slots 81 are employed, it is also understood that such slots may be spaced evenly around outer joint portion extension 72.

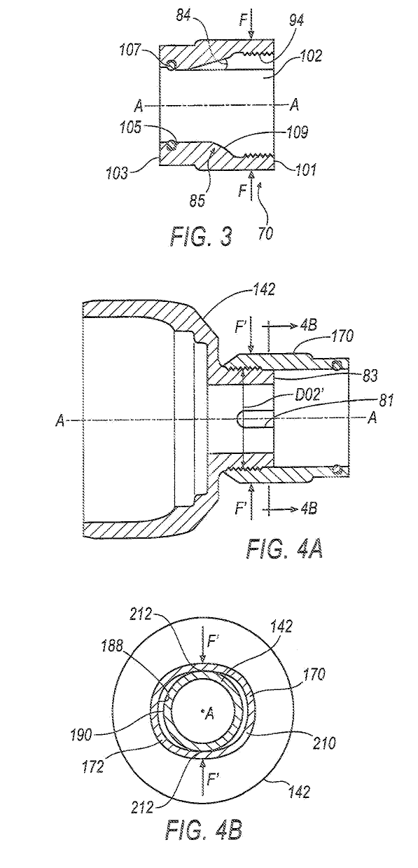

The compressive force F may be applied to the outer joint portion extension 72 of the outer joint portion 42 by the fastening device 70 (best seen in FIG. 3). That is, the fastening device 70 exerts the compressive force F at or adjacent to the second outer joint portion diameter DO2.

FIG. 3 is a partial sectional view of the fastening device 70. The fastening device 70 is configured with an internal bore 102 that extends between a front face 101 and a rear face 103. In one embodiment, adjacent the rear face, a recess 105 is disposed to retain a seal 107. In one exemplary embodiment, the seal is configured as an O-ring, though it is understood that any type of seal may be used. The seal 107 serves to prevent, or at least limit, the ingress of contaminants into the assembly 22.

Fastening device 70 further includes a joint portion threaded surface or connection portion 94 formed on an inside surface 109 of internal bore 102. Threaded surface 94 extends inwardly from front face 101 and is configured for engaging threads 96 formed on a portion of outer joint portion extension 72.

The fastening device 70 may further include a tapered portion 85, defined by angle 84, which is illustrated in both of FIGS. 2-3. The tapered portion 85 may be configured for exerting at least a portion of the compressive force F upon the outer joint portion extension 72 of the outer joint portion 42. Additionally, the tapered portion 85 may also ease the insertion of the fastening device 70 to the outer joint portion 42 during installation. The tapered portion 85 may be angled in a direction that extends downwardly away from the outer joint portion 42 and may facilitate installation of the fastening device 70. That is, as the fastening device 70 is advanced along the second shaft 30 and the outer joint portion extension 72 in a first direction A during installation, the tapered portion 85 may allow for a decreased amount of insertion force needed to advance the fastening device 70 along the second shaft 30 and the outer joint portion extension 72. In one exemplary illustration, the tapered angle 84 may be measured in the range of about eight and a half degrees to about eleven degrees)(8.5°-11°, however it is understood that the tapered angle may also include other dimensions as well.

FIG. 2 illustrates an embodiment of the outer joint portion 42 that also includes a tapered portion 93, defined by a tapered angle. The tapered portion 93 extends outwardly from front face 83, and toward threads 96 formed on a portion of outer joint portion extension 72. As may be seen in FIG. 2, the outer profile of the tapered portion 93 of the outer joint portion extension 72 may substantially coincide with the inner profile of the tapered portion 85 of the fastening device 70. Also, it should be noted that while FIGS. 1-3 illustrate the fastening device 70 as having the tapered portion 85 for exerting the compressive force F, the tapered portion 85 may be omitted. Instead, as illustrated in FIGS. 4A-4B, the fastening device 70 may also include an oval-shaped inner profile that cooperates with a generally circular outer profile of outer joint portion extension 72 for exerting the compressive force F′. This embodiment is discussed in further detail below.

The compressive force F assists in retaining the second shaft 30 inside of the outer joint portion 42, and may limit the amount of axial movement in the first direction A, and a second direction A′. The first direction of axial movement A is illustrated in FIG. 2 as being in a direction towards the main portion 86 of the outer joint portion 42, and the second direction of axial movement A′ is illustrated in a generally opposite direction, towards the second shaft 30. Compressing the outer joint portion 42 at the second outer joint portion diameter DO2 may limit the amount of axial movement in both of the first and second directions A and A′.

FIGS. 4A and 4B represent an alternative illustration of a fastening device 170, with the tapered portion 85 omitted. FIG. 4A illustrates the fastening device 170 engaged with an outer joint portion 142, and FIG. 4B is a partial cross sectional view of the fastening device 170 along lines 4B-4B in FIG. 4A. As shown in FIG. 4A, the fastening device 170 does not include the tapered portion 85 as seen in FIGS. 1-3 for engaging with the outer joint portion 142. Nor is outer joint portion 142 provided with a tapered portion. Instead, the fastening device 170 is engaged with and exerts a compressive force F′ upon a second outer joint portion diameter DO2′ by way of an oval inner profile 210, which is illustrated in FIG. 4B.

FIG. 4B illustrates the fastening device 170, which includes a non-circular profile, generally represented as the oval inner profile 210. It should be noted that while FIG. 4B illustrates an oval inner profile 210, any non-circular profile capable of exerting a compressive force may be used as well, and in one example the fastening device 170 includes a diamond-shaped profile.

The compressive force F′ is exerted along two generally opposing locations 212 of the fastening device 170. An outermost outer joint portion surface 190 contacts an inner outer joint portion surface 188. The oval inner profile 210 of the fastening device 170 compresses an outer joint portion extension 172 of the outer joint portion 142 at the two locations 212, where the outermost outer joint portion surface 190 contacts the inner outer joint portion surface 188. Therefore, the fastening device 170 may be able to exert the compressive force F′ without the tapered angle 84 as illustrated in FIGS. 1-3. It should be noted that while FIGS. 1-3 illustrate a tapered angle 84 and FIG. 4B illustrate an oval inner profile 210, other techniques for exerting a compressive force to the outer joint portion may be used as well.

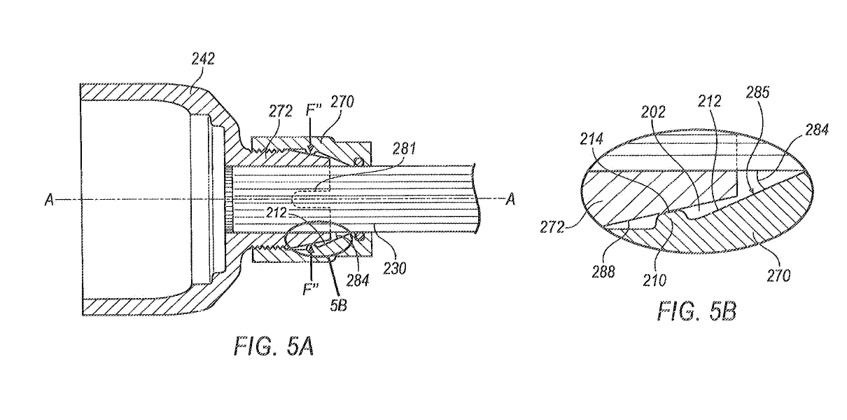

FIGS. 5A-5B show another alternative illustration of the fastening device 270 and the outer joint portion 242. As best seen in FIG. 5B, the fastening device 270 includes the tapered portion 285, defined by tapered angle 284, as well as at least one protuberance 210 located on the inner surface 212 of the inner bore 202 of the fastening device 270. In one representative embodiment, the protuberance 210 may be located along the tapered portion 285 of the inner surface 212. The protuberance 210 defines a contact surface 214 where the fastening device 270 contacts an outer surface 288 of the outer joint portion extension 272 contact one another.

However, referring back to FIG. 5A, while the contact surface 214 of the protuberance 210 contacts the outer surface 288 of the outer joint portion extension 272, the remaining portion of the inner surface 212 of the inner bore 202 may not be in contact with the outer surface 288. The protuberance 210 may be used in an effort to retain the outer joint portion extension 272 in relation to the fastening device 270 and the second shaft 230. The compressive force F″ may be exerted in the location where the protuberances 210 are located.

As discussed above, the outer profile of the outer joint portion extension 272 may substantially coincide with the inner profile of the tapered portion 285 of the fastening device 270. However, including the protuberance 210 may be advantageous, because the outer surface 288 may not need to substantially coincide with the tapered portion 285 if the protuberance 210 is included. That is, if the protuberance 210 is included with the fastening device 270, the remaining portion of the inner surface 212 along the tapered portion 285 may not be in contact with the outer surface 288. Therefore, because the inner surface 212 of the tapered portion 285 may not contact the outer surface 288, these two surfaces may not need to necessarily coincide with one another. As a result, greater tolerances may be included between the fastening device 270 and the outer joint portion 242 at the tapered angle 284.

The present disclosure has been particularly shown and described with reference to the foregoing embodiments, which are merely illustrative of the best modes for carrying out the disclosure. It should be understood by those skilled in the art that various alternatives to the embodiments of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. An outer joint portion (42) for an articulating joint (26), comprising:
a first outer joint diameter section (DO1) defined by a first portion of an outer surface (88) of the outer joint portion (42);
a second outer joint diameter section (DO2) defined by a second portion of the outer surface (88) of the outer joint portion (42);
a main portion (86) for housing inner components (44, 46) of an articulating joint (26), where the first outer joint diameter (DO1) is measured at the main portion (86); and
an inner bore (76) located at the second portion of the outer surface (88) where the outer joint portion (42) is selectively compressible at the second portion of the outer surface (88), the inner bore (76) configured for selectively receiving and securing to a shaft (30) when the outer joint portion (42) is compressed.

2. The outer joint portion (42) as recited in claim 1, wherein the first outer joint diameter (DO1) is greater than the second outer joint diameter (DO2).

3. The outer joint portion (42) as recited in claim 1, wherein the inner bore (76) includes a splined portion (78) for connection to a shaft (30).

4. The outer joint portion (42) as recited in claim 1, wherein the outer surface (88) includes a threaded surface (94) along a portion thereof at the second outer joint diameter (DO2).

5. The outer joint portion (42) as recited in claim 1, further comprising a tapered portion (85) extending outwardly from a front face (83) of the outer joint portion (42).

6. The outer joint portion (42) as recited in claim 1, further comprising at least one slot (81) extending from a front face (83).

7. An articulating joint (26), comprising:
an outer joint portion (42) including a first outer joint diameter section (DO1) and a second outer joint diameter section (DO2), an inner bore surface (76), and a connection portion (94);
wherein the first outer joint diameter section (DO1) is defined by a first portion of an outer surface (88) of the outer joint portion (42), and the second outer joint diameter section (DO2) is defined by a second portion of the outer surface (88) of the outer joint portion (42);
wherein the inner bore (76) of the outer joint portion (42) is defined by the second portion of the outer surface (88) of the outer joint portion (42) and selectively receives a shaft (30) therein;
wherein the outer joint portion (42) is selectively compressible at the second portion of the outer surface (88) for selective connection to a shaft (30); and
a fastening device (70) defined by a fastening device inner bore (102) extending therethrough, the fastening device receiving a portion of the outer joint portion (42) and clamped around the outer surface (88) of the outer joint portion (42) at the second portion of the outer surface (88) for selective compression of the second outer joint diameter section (DO2).

8. The articulating joint (26) as recited in claim 7, wherein the first outer joint diameter section (DO1) is greater than the second outer joint diameter section (DO2).

9. The articulating joint (26) as recited in claim 7, wherein the fastening device (70) includes a non-circular inner profile (210) for compressing the second portion of the outer surface (88).

10. The articulating joint (26) as recited in claim 7, wherein the fastening device (70) includes a threaded portion (94) that engages the connection portion (94) of the outer joint portion (42).

11. The articulating joint (26) as recited in claim 10, wherein the fastening device (70) further comprises a tapered portion (85) defined by a tapered angle (84), wherein the tapered portion (85) extends inwardly from a connection portion toward an axis (A-A) extending through the fastening device (70).

12. The articulating joint (26) as recited in claim 11, wherein the second outer joint diameter section (DO2) further includes a tapered portion (93) that generally corresponds to the tapered section (85) of the fastening device (70), the tapered portion (93) extending inwardly from the connection portion (96) toward a front face (83) of the second outer joint diameter section (DO2).

13. The articulating joint (26) as recited in claim 7, further comprising a seal member (107) disposed within the fastening device (70).

14. The articulating joint (26) as recited in claim 7, wherein the inner bore surface (76) includes a splined portion (78) for connection to the shaft (30).

15. The articulating joint (26) as recited in claim 7, wherein the shaft (30) is one of an output and an input shaft.

16. An articulating joint (26), comprising:
an outer joint portion (42) including a first outer joint diameter section (DO1) and a second outer joint diameter section (DO2), an inner bore surface (76), and a connection portion (94);
wherein the first outer joint diameter section (DO1) is defined by a first portion of an outer surface (88) of the outer joint portion (42), and the second outer joint diameter section (DO2) is defined by a second portion of the outer surface (88) of the outer joint portion (42);
wherein the inner bore surface (76) of the outer joint portion (42) is defined by the second portion of the outer surface (88) of the outer joint portion (42) and selectively receives a shaft (30) therein;
wherein the outer joint portion (42) is selectively compressible at the second portion of the outer surface (88) for selective connection to a shaft (30); and
a fastening device (70) defined by a fastening device inner bore (102) extending therethrough, the fastening device (70) receiving a portion of the outer joint portion (42) and having a connection portion that selectively and matingly engages the connection portion of the second outer joint diameter section (DO2) such that the fastening device (70) clamps around the outer surface (88) of the outer joint portion (42) at the second portion of the outer surface (88) for selective compression of the second outer joint diameter section (DO2).

17. The articulating joint (26) as recited in claim 16, wherein the connection portion of the fastening device (70) includes a non-circular inner profile (210) for contacting the connection portion (96) of the second outer joint diameter section (DO2) and compressing the second outer joint diameter section (DO2).

18. The articulating joint (26) as recited in claim 16, wherein the connection portion of the fastening device (70) is threaded and the connection portion (94) of the second outer joint diameter section (DO2) is threaded such that the fastening device (70) is configured for threaded engagement with the second outer joint diameter section (DO2).

19. The articulating joint (26) as recited in claim 18, wherein the fastening device (70) further comprises a tapered portion (85) defined by a tapered angle (84), wherein the tapered portion (85) extends inwardly from the connection portion (94) toward an axis (A-A) extending through the fastening device (70).

20. The articulating joint (26) as recited in claim 19, wherein the second outer joint diameter section (DO2) further includes a tapered portion (93) that generally corresponds to the tapered section (85) of the fastening device (70), the tapered portion (93) extending inwardly from the connection portion (94) toward a front face (83) of the second outer joint diameter section (DO2).
